(19) United States
(12) Patent Application Publication
(10) Pub. No.: US 2018/0198767 A1
(43) Pub. Date: Jul. 12, 2018

(54) METHOD AND DEVICE FOR PERFORMING PROXIMITY SERVICE COMMUNICATION IN WIRELESS COMMUNICATION SYSTEM

(71) Applicant: Samsung Electronics Co., Ltd., Gyeonggi-do (KR)

(72) Inventors: Dae-in CHOI, Gyeonggi-do (KR); Jae-jun LEE, Gyeonggi-do (KR); Young-kyo BAEK, Seoul (KR)

(21) Appl. No.: 15/740,965

(22) PCT Filed: Jun. 28, 2016
(86) PCT No.: PCT/KR2016/006907

§ 371 Date: Dec. 29, 2017

(30) Foreign Application Priority Data
Jun. 29, 2015 (KR) 10-2015-0092409

(51) Int. Cl. H04L 29/06; H04L 29/12; H04W 4/70; H04W 8/00; H04W 12/08; H04W 12/04

(52) U.S. Cl. CPC H04L 63/0492; H04L 61/2007; H04W 4/70; H04W 80/02; H04W 12/08; H04W 12/04; H04W 8/005

(57) ABSTRACT

Provided is a method of performing proximate service (ProSe) communication via a terminal, the method including: requesting, via the terminal, a layer-2 identifier (ID) of the terminal from a first entity; obtaining the layer-2 ID from the first entity in response to the request; and performing communication with another terminal included in a range of the obtained layer-2 ID, by using the obtained layer-2 ID.

### TECHNICAL FIELD

The present disclosure relates to a method and an apparatus for performing proximity service communication in a wireless communication system, and a recording medium having embodied thereon a program for executing the proximity service communication.

### BACKGROUND ART

Proximity service (ProSe) refers to a method of supporting communication between devices that are physically located close to each other. In detail, ProSe communication aims to support discovery of applications executed in devices that are close to each other and ultimately exchange of data related to the applications. For example, the ProSe may be applied to applications related to social network services (SNSs), commerce, games, etc.

ProSe communication may also be referred to as device-to-device (D2D) communication. That is, ProSe communication refers to a communication method whereby a plurality of devices (for example, pieces of user equipment (UE)) may directly exchange user data (for example, voice or multimedia data, etc.) without a network, by establishing a direct link between the plurality of devices. ProSe communication may include UE-to-UE communication, peer-to-peer communication, etc. Also, ProSe communication may be applied to machine-to-machine (M2M) communication, machine type communication (MTC), etc. Thus, ProSe communication has been considered as one of methods of reducing loads on a base station that are caused by rapidly increasing data traffic. Also, when ProSe communication is implemented, it is possible to expect effects, such as procedural reduction in base stations, power consumption reduction in devices engaging in ProSe communication, increased speed of data transmission, increased network capacity, load distribution, expanded cell coverage, etc.

### DETAILED DESCRIPTION OF THE DISCLOSURE

### Technical Problem

Embodiments disclosed herein relate to a method of determining identification information and security information used for communication, in a wireless communication system, when proximity service (ProSe) communication is performed between pieces of user equipment (UE).

### Technical Solution

Provided is a method of performing proximate service (ProSe) communication via a terminal, the method including: requesting, via the terminal, a layer-2 identifier (ID) of the terminal from a first entity; obtaining the layer-2 ID from the first entity in response to the request; and performing communication with another terminal included in a range of the obtained layer-2 ID, by using the obtained layer-2 ID.

### DESCRIPTION OF THE DRAWINGS

FIG. 1 is a view for describing a wireless communication system according to an embodiment.

FIG. 2 is a flowchart of a method of determining a data link hierarchy identifier (ID) (hereinafter, a layer-2 ID) of user equipment (UE) performing proximity service (ProSe) communication, according to an embodiment.

FIG. 3 is a flowchart of a method of determining an internet protocol (IP) address of a terminal, in a communication service between proximate terminals.

FIG. 4 is a flowchart of a method of sharing an IP address between UE1 and UE2.

FIG. 5 is a view for describing a method of setting security by using an ID of UE in ProSe communication, according to an embodiment.

FIG. 6 is a flowchart of an authorization procedure between pieces of UE in ProSe communication, according to an embodiment.

FIG. 7 is a flowchart of a method of protecting media streams between pieces of UE in ProSe communication, according to an embodiment.

FIG. 8 is a view of a discovery message used in ProSe communication, according to an embodiment.

FIGS. 9A and 9B are flowcharts of a discovery method between UE and a relay terminal in ProSe communication, according to an embodiment.

FIG. 10 is a block diagram of UE in which embodiments of the present disclosure are realized.

### BEST MODE

According to an aspect of the present disclosure, there is provided a method of performing proximate service (ProSe) communication via a terminal, the method including: requesting, via the terminal, a layer-2 identifier (ID) of the terminal from a first entity; obtaining the layer-2 ID from the first entity in response to the request; and performing communication with another terminal included in a range of the obtained layer-2 ID, by using the obtained layer-2 ID.

The method may further include: determining whether or not an internet protocol (IP) address assigned to the terminal exists, wherein the performing of the communication with the other terminal includes, when the IP address assigned to the terminal exists, performing, via the terminal performing the communication with the other terminal, the ProSe communication, based on the IP address.

The method may further include: transmitting a request message including the IP address, to the other terminal; and receiving, from the other terminal, a response message including an IP address of the other terminal and a layer-2 ID of the other terminal, wherein the performing of the communication with the other terminal includes performing, via the terminal performing the communication with the other terminal, the ProSe communication, based on the IP address of the terminal and the IP address of the other terminal.

The method may further include: when the IP address assigned to the terminal does not exist, assigning a new IP address to the terminal, wherein the performing of the communication with the other terminal includes performing, via the terminal performing the communication with the other terminal, the ProSe communication, based on the assigned new IP address.

The method may further include: transmitting a communication request message to the other terminal; receiving, from the other terminal, an authorization request message including a message authorization code; and transmitting, to the other terminal, a response message including the message authorization code obtained from the authorization request message, based on a group key set shared with the other terminal.

The method may further include: transmitting, to the other terminal, a code message including a group master key (GMK) shared with the other terminal and a group session key (GSK) of the terminal; and transmitting, to the other terminal, encrypted media streams, wherein the encrypted media streams are decrypted in the other terminal, based on the GSK of the terminal, which is included in the code message.

The method may further include: generating a discovery announcement message based on an encryption key shared with the other terminal; and detecting the other terminal as a relay terminal, when a response to the discovery announcement message is received from the other terminal.

According to another aspect of the present disclosure, there is provided a terminal configured to perform proximate service (ProSe) communication, the terminal including: a processor configured to obtain a layer-2 identifier (ID) of the terminal from a first entity in response to a request of the terminal, when the terminal requests the layer-2 ID of the terminal from the first entity; and a radio-frequency (RF) unit configured to perform communication with another terminal included in a range of the obtained layer-2 ID, by using the obtained layer-2 ID.

The processor may be further configured to determine whether or not an internet protocol (IP) address assigned to the terminal exists, and when the IP address assigned to the terminal exists, the RF unit may be further configured to perform the ProSe communication with the other terminal, based on the IP address.

The RF unit may be further configured to transmit a request message including the IP address to the other terminal, to receive, from the other terminal, a response message including an IP address of the other terminal and a layer-2 ID of the other terminal, and to perform the ProSe communication with the other terminal, based on the IP address of the terminal and the IP address of the other terminal.

When the IP address assigned to the terminal does not exist, the processor may be assigned with a new IP address, and the processor may be further configured to perform the communication with the other terminal based on the assigned new IP address.

The RF unit may be further configured to transmit a communication request message to the other terminal, to receive, from the other terminal, an authorization request message including a message authorization code, and to transmit, to the other terminal, a response message including the message authorization code obtained from the authorization request message, based on a group key set shared with the other terminal.

The RF unit may be further configured to transmit, to the other terminal, a code message including a group master key (GMK) shared with the other terminal and a group session key (GSK) of the terminal; and to transmit, to the other terminal, encrypted media streams, and the encrypted media streams may be decrypted in the other terminal, based on the GSK of the terminal, which is included in the code message.

The processor may be further configured to generate a discovery announcement message based on an encryption key shared with the other terminal, and to detect the other terminal as a relay terminal, when a response to the discovery announcement message is received from the other terminal.

According to another aspect of the present disclosure, there is provided a non-transitory computer-readable recording medium having embodied thereon a program for executing a method of performing proximate service (ProSe) communication via a terminal, the method including: requesting, via the terminal, a layer-2 identifier (ID) of the terminal from a first entity; obtaining the layer-2 ID from the first entity in response to the request; and performing communication with another terminal included in a range of the obtained layer-2 ID, by using the obtained layer-2 ID.

### MODE OF THE DISCLOSURE

In embodiments to be described hereinafter, components and features of the present disclosure are combined in a predetermined form. Unless there is an additional explicit comment, it may be considered that each component or feature is optional. Each component or feature may be implemented in a form in which the component or feature is not combined with other components or features. Also, the embodiments of the present disclosure may include a combination of components and/or features. Orders of operations described in the embodiments of the present disclosure may be changed. Some components or features of some embodiments may be included in other embodiments, or may be replaced with corresponding components or features of other embodiments.

Specific terms used in the description hereinafter are provided to help understand the present disclosure, and these terms may be changed to other terms within a range of a technical concept of the present disclosure.

In some cases, in order not to blur the concept of the present disclosure, known structures and devices may be omitted, or block diagrams may be illustrated by focusing on an essential function of each component and device. Also, like reference numerals refer to like elements throughout the specification.

The embodiments of the present disclosure may be supported by standard documents disclosed related to at least one of an institute of electrical and electronics engineers (IEEE) 802-based system, a third generation partnership project (3GPP) system, a 3GPP long term evolution (LTE) system, a 3GPP LTE-A system, and a 3GPP2 system. That is, operations or parts of the embodiments of the present disclosure, which are not described to clearly convey the technical concept of the present disclosure, may be supported by the documents. Also, all the terms disclosed in the present specification may be explained based on the standard documents.

Techniques described hereinafter may be used in various wireless communication systems. For clarity, descriptions will be given by focusing on the 3GPP LTE and 3GPP LTE-A systems. However, the technical concept of the present disclosure is not limited thereto.

The terms used in this specification are defined as below.
User equipment (UE): a user device. The UE may be referred to as a terminal, mobile equipment (ME), a mobile station (MS), etc. Also, the UE may include portable devices, such as a notebook computer, a cellular phone, a personal digital assistant (PDA), a smart phone, a multimedia device, etc., or non-portable devices, such as a personal computer (PC), a vehicle-installed device, etc. The UE may perform communication via 3GPP spectrum, such as LTE, and/or non-3GPP spectrum, such as Wifi and public safety spectrum.
Proximity service or proximity-based service (ProSe): a service to enable a discovery between physically close devices, and direct communication/communication via a base station/communication via a third device between the physically close devices. Here, user plane data is exchanged via a direct data path without passing through a 3GPP core network (for example, evolved packet core (EPC)).

g a method whether or not a certain piece of UE is close to another piece of UE is determined based on whether a predetermined proximity reference is satisfied. ProSe discovery and ProSe communication may have different proximity references. Also, the proximity reference may be set under control of a business operator.
ProSe discovery: a process to use E-UTRA or to identify which piece of UE is close to which piece of UE.
ProSE communication: communication between pieces of UE that are close to each other, wherein the communication is performed via a communication path established between the pieces of UE. The communication path may be directly established between the pieces of UE or may be routed via a local base station(s) (eNodeB).

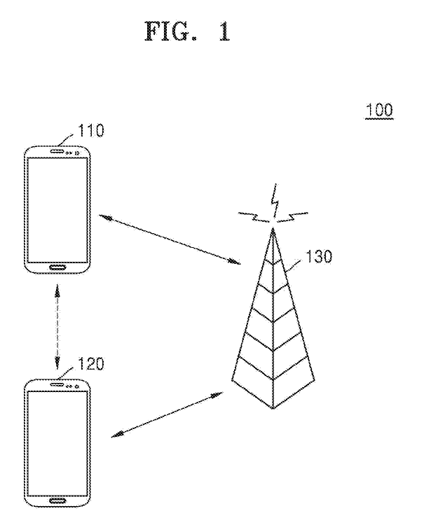

FIG. 1 is a view for describing a wireless communication system 100 according to an embodiment.

The wireless communication system 100 according to an embodiment may include UE1 110, UE2 120, and a base station 130.

In the wireless communication system 100 illustrated in FIG. 1, only components according to the present embodiment are shown. That is, it would be understood by one of ordinary skill in the art that other general-purpose components may further be included in the wireless communication system 100, in addition to the components illustrated in FIG. 1.

The UE1 110 and the UE2 120 according to an embodiment may perform ProSe one-on-one direct communication. In the ProSe one-on-one direct communication according to an embodiment, each of the UE1 110 and the UE2 120 may have a layer-2 identifier (ID) for the direct communication between the UE1 110 and the UE120 via a wireless interface (for example, PC5). In the wireless communication system 100 according to an embodiment, at least one entity of ProSe function (PF), ProSe key management function (PKMF), and UE may determine the layer-2 ID of the UE.

Meanwhile, when the UE1 110 and the UE2 120 according to an embodiment have an internet protocol (IP) address, the UE1 110 and the UE2 120 may re-use the IP address. The IP address of the UE1 110 and the UE2 120 may be shared via PC5 signaling.

Also, the UE1 110 and the UE2 120 according to an embodiment may generate a security key by using the ID of each of the UE1 110 and the UE2 120, rather than a group ID, for bearer level security. Also, the UE1 110 and the UE2 120 may generate a security key by using the ID of each of the UE1 110 and the UE2 120, rather than the group ID, for encryption of media data.

Meanwhile, when at least one of the UE1 110 and the UE2 120 according to an embodiment performs communication with a relay terminal, the UE1 110 or the UE2 120, and the relay terminal may have a same key that is pre-set. The UE (for example, the UE1 110) and the relay terminal may each use the same key shared between the UE and the relay terminal and an ID in order to transmit and receive a discovery message.

Also, when the UE1 110 and the UE2 120 according to an embodiment generate Message Integrity Check (MIC), a signature used for code authorization, the UE1 110 and the UE2 120 may generate the MIC by using only their own IDs, without other information. As another example, other parameters in addition to the IDs of the UE1 110 and the UE2 120 may be used to generate the MIC.

The base station 130 according to an embodiment generally refers to a station configured to communicate with at least one of the relay terminal and the UE. Other terms of the base station 130 may include evolved-NodeB (eNodeB), base transceiver system (BTS), access point (AP), femto-eNB, pico-eNB, home eNB, relay, etc. The base station 130 may provide at least one cell to at least one of the relay terminal 130 and a terminal 140. The cell may denote a geographical area, for which the base station 20 provides the communication service, or may denote a predetermined frequency zone. The cell may denote a downlink frequency resource and an uplink frequency resource. Alternatively, the cell may denote a combination of the downlink frequency resource and an optional uplink frequency resource.

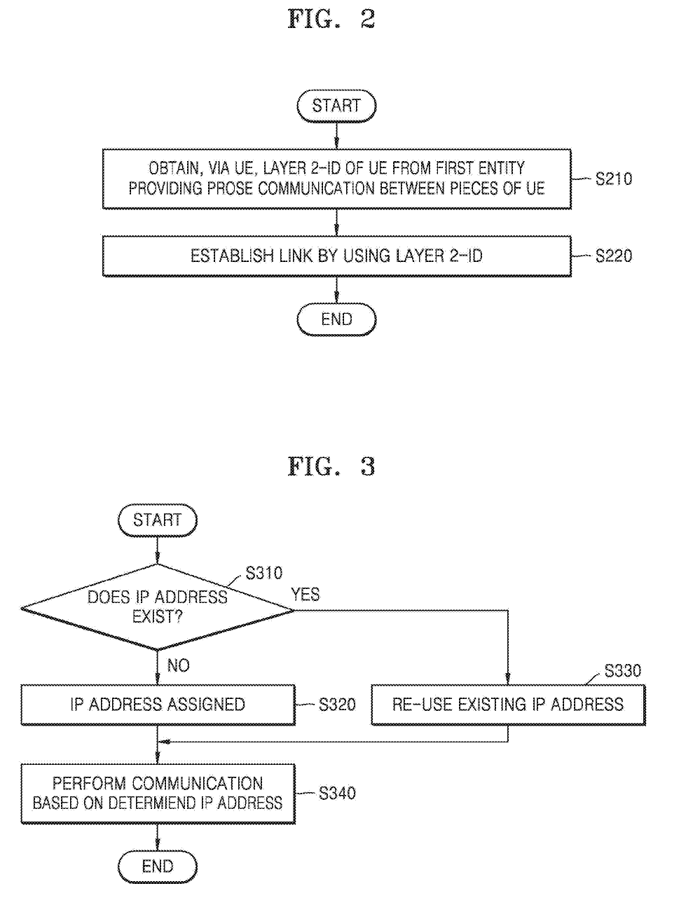

FIG. 2 is a flowchart of a method of determining a data link hierarchy ID (hereinafter, a layer-2 ID) of UE performing ProSe communication, according to an embodiment.

In operation S210, the UE may request the layer-2 ID of the UE from a first entity configured to provide the ProSe communication.

The layer-2 ID has to be unique and non-repeated in a local, and has to be used in a same manner in a plurality of data link hierarchies. In a wireless communication system according to an embodiment, a UE ID for group communication in one-to-many ProSe communication may be used as the layer-2 ID.

In a ProSe one-to-one direct communication according to an embodiment, each piece of UE may have the layer-2 ID, for direct communication between the pieces of UE via a wireless interface (for example, PC5). For example, for unicast communication, each of frames transmitted from UE1 to UE2 may need a source layer-2 ID and a target layer-2 ID. Also, bearer level security may be applied for the security of data link hierarchy communication via the PC5.

In a wireless communication system according to an embodiment, at least one entity of PF, PKMF, and UE may determine the layer-2 ID of the UE.

For example, the PF may determine the layer-2 ID of the UE. The PF may provide the layer-2 ID to the UE during a service authorization process. Here, security parameters based on SA3 WG may be provided from the PKMF. When a value of the layer-2 ID is unique in each of layer-2 groups, the PKMF may provide the PF with the layer-2 ID for the unicast communication, as a ProSe UE ID.

According to another embodiment, the PKMF may determine the layer-2 ID of the UE.

For example, the UE may reuse a ProSe UE ID assigned for group communication. Here, security parameters for one-to-one communication may be provided from the PKMF. When the UE is assigned to any one of layer-2 groups for one-to-many communication, the UE may use the ProSe UE ID assigned for the ProSe group communication, as the layer-2 ID for the unicast communication.

As another example, the PKMF may assign the layer-2 ID for the unicast communication together with security parameters to the UE. The PKMF may determine a value of the layer-2 ID for the unicast communication as the ProSE UE ID of a plurality of layer-2 groups.

According to another embodiment, the UE may determine the layer-2 ID for the unicast communication on its own. The security parameters may be provided from the PKMF. Here, the UE may need to check that the layer-2 ID for the unicast communication is unique in a local.

According to an embodiment, when collision of the layer-2 ID is detected, the UE may determine the layer-2 ID for the unicast communication on its own.

Meanwhile, hereinafter, a detailed method in which the UE is provided with the layer-2 ID from the first entity will be described. Here, the first entity may receive the layer-2 ID of the UE from another entity, that is, a second entity, and provide the received layer-2 ID of the UE to the UE.

The PF according to an embodiment may manage the UE ID or the layer-2 ID for one-to-one communication, and each PF may have unique UE ID or unique layer-2 ID.

The PKMF according to an embodiment may manage the UE ID or the layer-2 ID for one-to-one communication, and each PF may have unique UE ID or unique layer-2 ID.

The PF according to an embodiment may provide the UE ID or the layer-2 ID for one-to-one communication to the PKMF. For example, the PF may provide the UE ID or the layer-2 ID of each piece of UE. As another example, the PF may provide at least one list including at least one UE ID or at least one layer-2 ID for a group. As another example, the PF may provide a range of at least one UE ID or at least one layer-2 ID for a group.

When the PF according to an embodiment receives a request of ProSe discovery authorization or a direct communication service authorization, the PF may provide at least one UE ID or at least one layer-2 ID to the PKMF.

When the PKMF requests a UE ID or at least one layer-2 ID with respect to a specific piece of UE or a group from the PF, the PF according to an embodiment may provide at least one UE ID or at least one layer-2 ID to the PKMF.

The UE according to an embodiment may request at least one UE ID or at least one layer-2 ID from the PKMF.

The PKMF according to an embodiment may provide the at least one UE ID or the at least one layer-2 ID, together with other parameters, such as security parameters.

The PF according to an embodiment may manage the UE ID or the layer-2 ID for one-to-one communication, and each PF may have unique UE ID or unique layer-2 ID.

The PKMF according to an embodiment may manage the UE ID or the layer-2 ID for one-to-one communication, and each PKMF may have to guarantee that the UE ID or the layer-2 ID is unique.

The PKMF according to an embodiment may provide, to the PF, the UE ID or the layer-2 ID for one-to-one communication. For example, the PKMF may provide the UE ID or the layer-2 ID of each piece of UE. As another example, the PKMF may provide at least one list including at least one UE ID or at least one layer-2 ID for a group. As another example, the PKMF may provide a range of at least one UE ID or at least one layer-2 ID for a group.

When the PKMF according to an embodiment receives a request of ProSe discovery authorization or direct communication service authorization, the PKMF may provide at least one UE ID or at least one layer-2 ID to the PF.

When the PF requests a UE ID or at least one layer-2 ID with respect to a specific piece of UE or a group from the PKMF, the PKMF according to an embodiment may provide at least one UE ID or at least one layer-2 ID to the PF. The UE according to an embodiment may request at least one UE ID or at least one layer-2 ID from the PF.

The PF according to an embodiment may provide the at least one UE ID or the at least one layer-2 ID to the UE.

The UE according to an embodiment may request the at least one UE ID or the at least one layer-2 ID, together with other parameters (for example, security parameters), from the PF.

The PF according to an embodiment may provide, to the UE, the at least one UE ID or the at least one layer-2 ID, together with the other parameters (for example, the security parameters).

In operation S220, the UE may perform direct communication with another piece of UE via a wireless interface (for example, PC5), by using the layer-2 ID.

FIG. 3 is a flowchart of a method of determining an IP address of a terminal in a communication service between proximate terminals, according to an embodiment.

In operation S310, UE may identify whether the UE has an IP address.

In operation S320, the UE may receive the IP address.

When the UE does not have an IP address, the UE may receive an IPv4 address or an IPv6 address via DHCP. For example, any one of two pieces of UE, that is, UE1 and UE2, may operate as a DHCP server or an IPv6 router, in communication between the UE1 and the UE2. As another example, in the case of a Prose UE-network relay, a relay terminal may operate as the DHCP server or the IPv6 router for at least one piece of UE connected to the relay terminal.

In operation S330, when the UE has an IP address, the UE may reuse the IP address. The UE according to an embodiment may use a link local IP address as the IP address in one-to-one communication. As another example, the UE may reuse the existing IP address. The IP address of the UE may be shared via PC5 signaling.

In operation S340, the UE may perform communication based on the determined IP address.

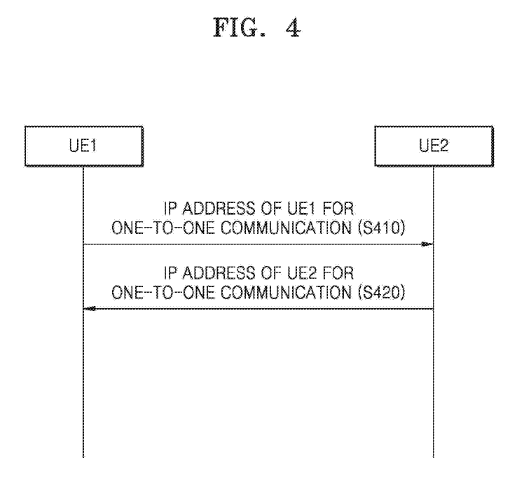

FIG. 4 is a flowchart of a method in which UE1 and UE2 share an IP address, according to an embodiment.

Each of the UE1 and the UE2 according to an embodiment may identity whether or not an IP address exists. When the IP address exists for the UE1 and the UE2, the UE1 and the UE2 may perform communication by using the existing IP address, without newly generating an IP address.

In operation S410, the UE1 may transmit IP address information of the UE1 for one-to-one communication to the UE2.

In operation S420, the UE2 may transmit IP address information of the UE2 for one-to-one communication to the UE1.

Here, the IP address information may include at least one parameter. For example, the IP address information may include at least one of a message type, an operation type, a transaction ID, an IP of a transmitter, a layer-2 ID of the transmitter, an IP of a receiver, and a layer-2 ID of the receiver. Here, the message type may include any one of a request, a response, and a refusal or denial. Also, the operation type may include any one of one-to-one communication, UE network relay, relay between pieces of UE, and relay in a UE group.

According to an embodiment, when the message type includes the request, the message may include an IP of a transmitter and a layer-2 ID of the transmitter. Other fields may be optional.

According to an embodiment, when the message type is the response, the message may include an IP of a transmitter, a layer-2 ID of the transmitter, an IP of a receiver, and a layer-2 ID of the receiver. Other fields may be optional.

According to an embodiment, when the UE does not have an IP address, the UE may receive a message of refusal.

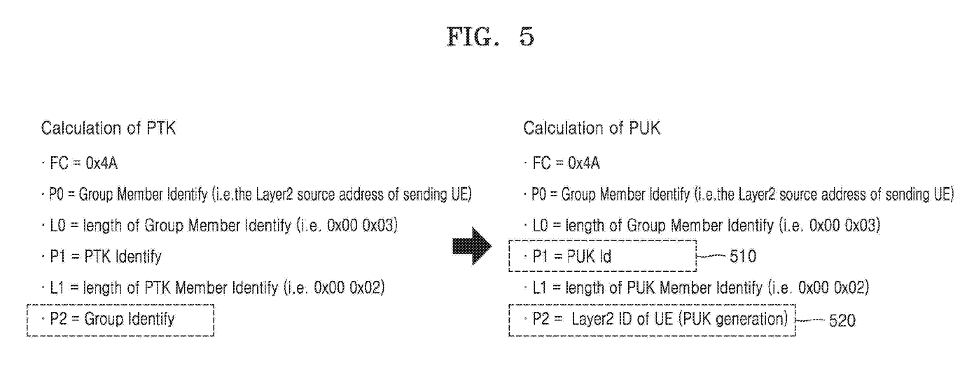

FIG. 5 is a view for describing a method of setting security by using an ID of UE in ProSe communication, according to an embodiment.

(a) of FIG. 5 is a view summarizing parameters for generating a ProSe traffic key (PTK) used for one-to-many communication.

In the ProSe communication, a ProSe group key (hereinafter, a PGK) may be used for bearer level security. Terminals included in a group may generate the PTK from the PGK. The PTK may be generated based on identification information of group members, length of the identification information of group members, PTK identification information, length of the PTK identification information, group identification information, etc. Also, the terminals may generate a ProSe encryption key (PEK) and a ProSe integrity key (PIK) from the PTK. Here, referring to (a) of FIG. 5, it is identified that the group identification information is included in the plurality of parameters for generating the PTK.

Meanwhile, (b) of FIG. 5 is a view for describing a method of generating a ProSe unicast traffic key (PUK) by using an ID of UE, according to an embodiment.

The UE according to an embodiment may generate the PUK from the PGK, by using the UE ID for one-to-one communication. For example, the PUK may be generated based on group member identification information, length of the group member identification information, PUK identification information 510, length of the PUK identification information 510, and a UE ID 520.

Also, the UE may generate the PEK and PIK from the PUK. The PUK according to an embodiment may be used for bearer level security in UE-network relay communication, one-to-one communication, etc. Meanwhile, a layer-2 ID used to generate the PUK in the one-to-one communication is the ID of UE requesting authorization. However, the layer-2 ID may be the ID of UE requesting direct communication, based on settings.

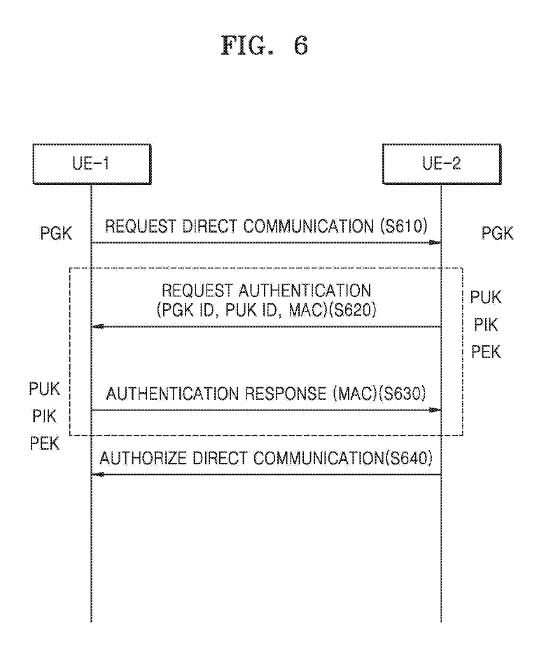

FIG. 6 is a flowchart of an authorization procedure between pieces of UE, namely, UE1 and UE2, in ProSe communication, according to an embodiment.

In operation S610, the UE1 may transmit a request of direct communication to the UE2.

Meanwhile, the UE1 and the UE2 are terminals included in a same group and may have a same PGK.

In operation S620, the UE2 may transmit an authorization request to the UE1. Here, the authorization request may include a PGK ID, a PUK ID, and a message authorization code (MAC).

Meanwhile, the UE2 may generate a PIK and a PEK from the PUK. Also, the UE1 may generate the PUK, the PIK, and the PEK.

In operation S630, the UE1 may transmit an authorization response to the UE2. Here, the authorization response may include the MAC.

In operation S640, the UE2 may authorize the request of direct communication of the UE1.

According to an embodiment, the MAC of the UE2 and the MAC of the UE1 are the same, and thus, the UE2 may authorize the request of direct communication of the UE1.

Meanwhile, as another example, when the PTK of group communication is used for one-to-one communication, each piece of UE included in a group may filter messages, the target of which is not the piece of UE, by using at least one of a layer-2 ID and an IP address.

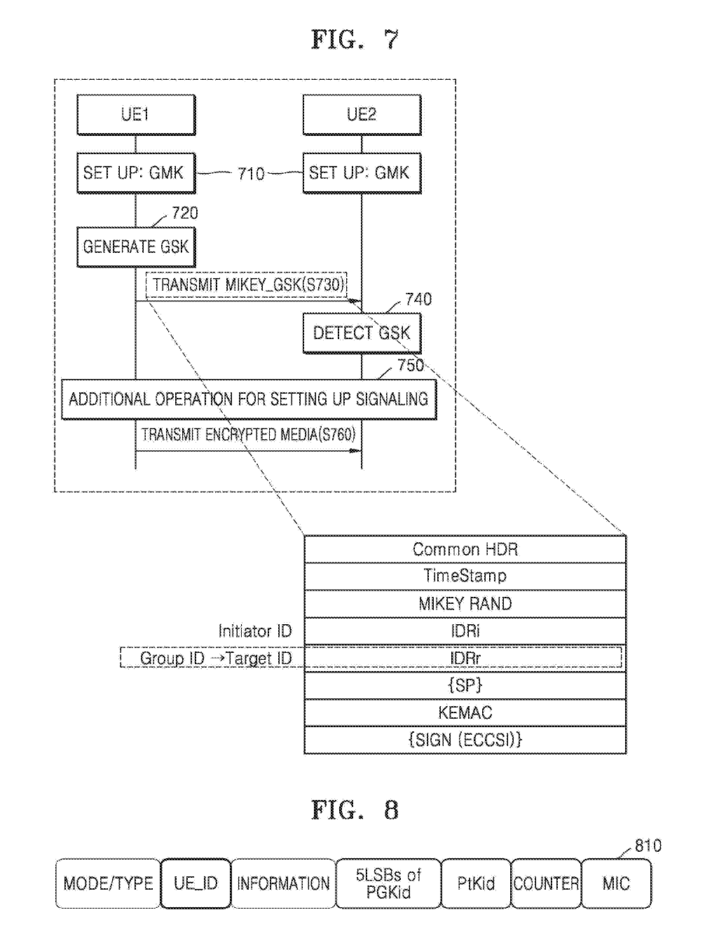

FIG. 7 is a flowchart of a method of protecting media streams between pieces of UE, namely, UE1 and UE2, in ProSe communication, according to an embodiment.

In operation S710, the UE1 and the UE2 may each set up a group master key (GMK). Here, the GMK may be a key shared by terminals in a group.

In operation S720, the UE1 may generate a group session key (GSK).

In operation S730, the UE1 may transmit MIKEY_GSK to the UE2. Here, the UE2 may obtain information about the GSK, via the MIKEY_GSK. The UE1 according to an embodiment may generate the MIKEY message by using an ID of a target, the UE2, rather a group ID.

In operation S740, the UE2 may detect the GSK.

In operation S750, other operations necessary for setting-up signaling may be performed.

In operation S760, when the setting-up is completed, encrypted media may be transmitted from the UE1 to the UE2.

Meanwhile, as another example, when the MIKEY message generated by using the group ID is used for one-to-one communication, each piece of UE included in the group may filer messages, the target of which is not the piece of UE, by using at least one of a layer-2 ID and an IP address.

FIG. 8 is a view showing a discovery message used for ProSe communication, according to an embodiment.

UE according to an embodiment may use only a UE ID to generate an MIC 810 included in the discovery message. As another example, other parameters may also be used, in addition to the UE ID. Also, according to an embodiment, a PIK may be used to authorize the discovery message.

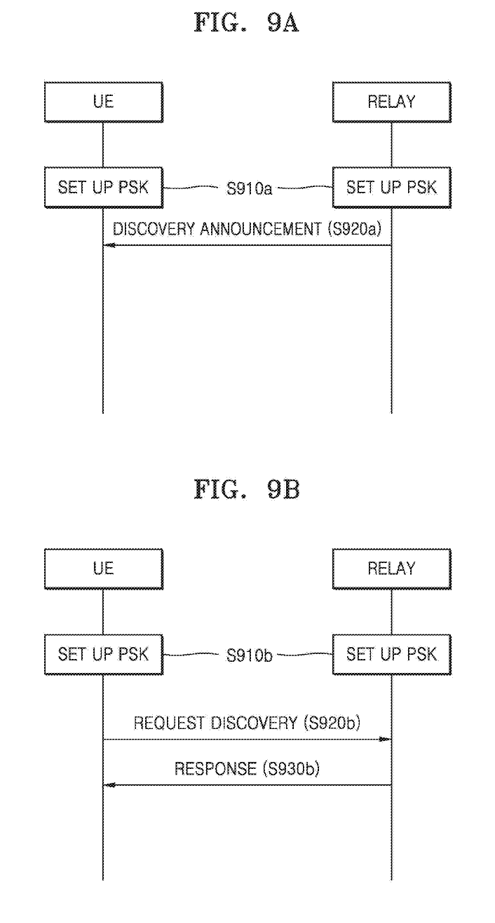

FIGS. 9A and 9B are flowcharts of a discovery method between UE and a relay terminal in ProSe communication according to an embodiment.

The UE and the relay terminal illustrated in FIGS. 9A and 9B may have a same PSK. Here, the PSK may be provided to the UE and the relay terminal for the ProSe.

Referring to FIG. 9A, in operation S910a, each of the UE and the relay terminal may set up the PSK.

In operation S920a, the relay terminal may transmit a discovery announcement message to the UE by using the PSK. Here, the relay terminal according to an embodiment may generate the MIC included in the discovery announcement message by using only the ID of the relay terminal. As another example, other parameters, in addition to the UE ID), may also be used to generate the MIC.

Referring to FIG. 9B, in operation S910b, each of the UE and the relay terminal may set-up the PSK.

In operation S920b, the UE may transmit a discovery request message to the relay terminal. The UE according to an embodiment may transmit a discovery announcement message to the relay terminal by using the PSK. Here, the UE according to an embodiment may generate the MIC included in the discovery announcement message by using only the ID of the UE. As another example, other parameters, in addition to the ID of the UE, may also be used to generate the MIC.

In operation S930b, the relay terminal may transmit a response message to the UE. The relay terminal according to an embodiment may transmit the response message to the UE by using the PSK. Here, the relay terminal according to an embodiment may generate the MIC included in the response message by using only the ID of the relay terminal. As another example, other parameters, in addition to the UE ID, may also be used.

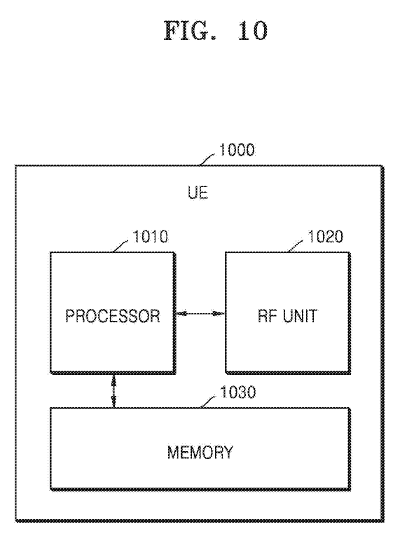

FIG. 10 is a block diagram of UE 1000 in which embodiments of the present disclosure are realized.

The UE 1000 may include a processor 1010, an RF unit 1020, and a memory 1030.

The processor 1010 implements provided functions, processes, and/or methods. The operations of the UE 1000 described above may be implemented by the processor 1010. The processor 1010 according to an embodiment may perform ProSe one-to-one direct communication with another piece of UE. The processor 1010 may request a layer-2 ID of the UE 1000 from a first entity providing the ProSe communication. Also, the processor 1010 may directly generate the layer-2 ID.

Meanwhile, when the processor 1010 according to an embodiment has an IP address, the processor 1010 may re-use the IP address. Also, the processor 1010 according to an embodiment may generate a security key by using an ID of the UE 1000 rather than a group ID, for bearer level security. Also, the processor 1010 may generate a security key by using the ID of the UE 1000 rather than the group ID, for encryption of media data.

Meanwhile, when the UE 1000 performs communication with at least one relay terminal, the processor 1010 according to an embodiment may transmit and receive a discovery message by using a same key shared by the UE 1000 and the at least one relay terminal, and an ID of each of the UE 1000 and the at least one relay terminal.

Also, when the processor 1010 according to an embodiment generates an MIC, a signature used for code authorization, the processor 1010 may generate the MIC by using only the ID of the UE 1000, without other information. However, this is only an embodiment. As another example, other parameters, in addition to the ID of the UE 1000, may also be used to generate the MIC.

The RF unit 1020 may transmit and/or receive a wireless signal in connection with the processor 1010. The memory 1030 may store a protocol or a parameter for operations, in connection with the processor 1010.

The processor 1010 may include application-specific integrated circuits (ASICs), other chipsets, other logic circuits, and/or other data processors. The memory 1030 may include read-only memory (ROM), random-access memory (RAM), flash memory, a memory card, a storage medium and/or other storage devices. The RF unit 1020 may include a baseband circuit for processing wireless signals. When the embodiments are implemented as software, the methods described above may be implemented via a module (a process, a function, etc.) configured to perform the described functions. The module may be stored in the memory 1030 and executed by the processor 1010. The memory 1030 may be mounted inside or outside the processor 1010, and may be connected to the processor 1010 via various well-known devices.

In the example system described above, the methods are described as a series of operations or blocks, based on the flowcharts. However, the present disclosure is not limited to the orders of the operations. Some operations may be performed in an order different from the order described above, and the operations may be performed in different orders or simultaneously. Also, it would be understood by one of ordinary skill in the art that the illustrated flowcharts are not exclusive, and the flowcharts may further include other operations, or one or more operations of the flowcharts may be omitted without affecting the scope of the present disclosure.

The embodiments described above include various examples. Although not all the possible combinations included in the various examples can be described, one of ordinary skill in the art would recognize that other combinations are possible. Thus, it would be understood that the present disclosure includes all other substitutions, modifications and corrections within the scope of the claims described hereinafter.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the disclosure, reference has been made to the exemplary embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art.

The present disclosure may be described in terms of functional block components and various processing steps. Such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, where the elements of the present disclosure are implemented using software programming or software elements the disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present disclosure could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential” or “critical.”

1. A method of performing proximate service (ProSe) communication via a terminal, the method comprising:
requesting, via the terminal, a layer-2 identifier (ID) of the terminal from a first entity;
obtaining the layer-2 ID from the first entity in response to the request; and
performing communication with another terminal comprised in a range of the obtained layer-2 ID, by using the obtained layer-2 ID.

2. The method of claim 1, further comprising:
determining whether or not an internet protocol (IP) address assigned to the terminal exists,
wherein the performing of the communication with the other terminal comprises, when the IP address assigned to the terminal exists, performing, via the terminal performing the communication with the other terminal, the ProSe communication, based on the IP address.

3. The method of claim 2, further comprising:
transmitting a request message comprising the IP address, to the other terminal; and
receiving, from the other terminal, a response message comprising an IP address of the other terminal and a layer-2 ID of the other terminal,
wherein the performing of the communication with the other terminal comprises performing, via the terminal performing the communication with the other terminal, the ProSe communication, based on the IP address of the terminal and the IP address of the other terminal.

4. The method of claim 2, further comprising:
when the IP address assigned to the terminal does not exist, assigning a new IP address to the terminal,
wherein the performing of the communication with the other terminal comprises performing, via the terminal performing the communication with the other terminal, the ProSe communication, based on the assigned new IP address.

5. The method of claim 1, further comprising:
transmitting a communication request message to the other terminal;
receiving, from the other terminal, an authorization request message comprising a message authorization code; and
transmitting, to the other terminal, a response message comprising the message authorization code obtained from the authorization request message, based on a group key set shared with the other terminal.

6. The method of claim 1, further comprising:
transmitting, to the other terminal, a code message comprising a group master key (GMK) shared with the other terminal and a group session key (GSK) of the terminal; and
transmitting, to the other terminal, encrypted media streams,
wherein the encrypted media streams are decrypted in the other terminal, based on the GSK of the terminal, which is comprised in the code message.

7. The method of claim 1, further comprising:
generating a discovery announcement message based on an encryption key shared with the other terminal; and
detecting the other terminal as a relay terminal, when a response to the discovery announcement message is received from the other terminal.

8. A terminal configured to perform proximate service (ProSe) communication, the terminal comprising:
a processor configured to obtain a layer-2 identifier (ID) of the terminal from a first entity in response to a request of the terminal, when the terminal requests the layer-2 ID of the terminal from the first entity; and
a radio-frequency (RF) unit configured to perform communication with another terminal comprised in a range of the obtained layer-2 ID, by using the obtained layer-2 ID.

9. The terminal of claim 8, wherein the processor is further configured to determine whether or not an internet protocol (IP) address assigned to the terminal exists, and
when the IP address assigned to the terminal exists, the RF unit is further configured to perform the ProSe communication with the other terminal, based on the IP address.

10. The terminal of claim 9, wherein the RF unit is further configured to transmit a request message comprising the IP address to the other terminal,
to receive, from the other terminal, a response message comprising an IP address of the other terminal and a layer-2 ID of the other terminal, and
to perform the ProSe communication with the other terminal, based on the IP address of the terminal and the IP address of the other terminal.

11. The terminal of claim 9, wherein when the IP address assigned to the terminal does not exist, the processor is assigned with a new IP address, and
the processor is further configured to perform the communication with the other terminal based on the assigned new IP address.

12. The terminal of claim 8, wherein the RF unit is further configured to transmit a communication request message to the other terminal,
to receive, from the other terminal, an authorization request message comprising a message authorization code, and
to transmit, to the other terminal, a response message comprising the message authorization code obtained from the authorization request message, based on a group key set shared with the other terminal.

13. The terminal of claim 8, wherein the RF unit is further configured to transmit, to the other terminal, a code message comprising a group master key (GMK) shared with the other terminal and a group session key (GSK) of the terminal; and to transmit, to the other terminal, encrypted media streams, and
the encrypted media streams are decrypted in the other terminal, based on the GSK of the terminal, which is comprised in the code message.

14. The terminal of claim 8, wherein the processor is further configured to generate a discovery announcement message based on an encryption key shared with the other terminal, and
to detect the other terminal as a relay terminal, when a response to the discovery announcement message is received from the other terminal.

15. A non-transitory computer-readable recording medium having embodied thereon a program for executing the method of claim 1.
